(19) United States
(12) Patent Application Publication
(10) Pub. No.: US 2016/0170971 A1
(43) Pub. Date: Jun. 16, 2016

(54) OPTIMIZING A LANGUAGE MODEL BASED ON A TOPIC OF CORRESPONDENCE MESSAGES

(71) Applicant: Nuance Communications, Inc., Burlington, MA (US)

(72) Inventors: Michael McSherry, Seattle, WA (US); Sundar Balasubramanian, Seattle, WA (US)

(21) Appl. No.: 14/570,934

(22) Filed: Dec. 15, 2014

(51) Int. Cl. G06F 17/28; G06F 17/27

(52) U.S. Cl. CPC G06F 17/28; G06F 17/277

(57) ABSTRACT

Technology for optimizing a language model based on a topic identified in correspondence messages. The system may continuously or periodically optimize a language model based on topics identified in past correspondence messages or topics anticipated based on an intended recipient of a correspondence message being drafted. The system can operate in combination or conjunction with a language prediction system, such as a next word prediction application used by a virtual keyboard, thus providing improved language prediction for conversations related to identified topics.

### BACKGROUND

Computing devices receive text from users through various input modes. Typically, these input modes include a text input mode, a speech input mode, and/or a handwriting input mode. An objective underlying these input modes is to enable users to create text and enter other information with increased reliability at increased rates. To this end, computing devices often provide predictive language features, such as next word prediction.

To predict a user's textual input, computing devices rely upon language models with a lexicon of textual objects that are chosen based on input by the user. These models are often dynamic and grow and learn as they are used, allowing a user to improve the baseline prediction with usage and teaching.

Unfortunately, language models often do not perfectly match users' language usage, reducing the accuracy of word prediction. For example, if a word is not frequently used, a device might not predict the word with very high accuracy. Among the words that are commonly not predicted are proper names, such as those for people, streets, and restaurants, and other words that have a special relevance in conversation.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

Embodiments of the present disclosure will be described and explained through the use of the accompanying drawings in which:

FIG. 1 is a diagram of a suitable environment in which a system for optimizing a language model may operate;

FIG. 2 is a block diagram of a system for optimizing a language model;

FIG. 3 is a flow diagram depicting a method performed by a system for optimizing a language model based on a topic identified in correspondence messages;

FIG. 4 shows representative correspondence messages between a user and a party;

FIG. 5 is a representative table showing topics and text associated with those topics; and

FIG. 6 shows a representative user interface including a virtual keyboard using a language prediction application that utilizes an optimized language model generated by a system according to the present disclosure.

### DETAILED DESCRIPTION

A method and system are described for optimizing a language model based on a topic identified in correspondence messages. The system may continuously or periodically optimize a language model based on topics identified in past correspondence messages or topics anticipated based on an intended recipient of a correspondence message being drafted. The system can operate in combination or conjunction with a language prediction system, such as a next word prediction application used by a virtual keyboard, thus providing improved language prediction for conversations related to identified topics.

The system optimizes a language model by raising a priority for words or combinations of words of a language model if they are determined to be relevant to an identified topic. The system maintains past correspondence messages between two or more parties. One party may be a user of a device on which the system operates. The system receives an instruction to optimize a language model. The system identifies a topic in past correspondence messages or anticipates a topic for text being entered by a user based on information received with the instruction to optimize a language model. For example, the instruction may identify an intended recipient of a message, and the system may identify a topic based on the intended recipient. The system adjusts a priority for words or combinations of words in an identified language model based on identified topics.

Traditional language prediction systems operate on a device and are isolated from both sides of a conversation. Consequently, they only have access to words used by one party to a conversation, who is generally the user of the device. The system of the present disclosure receives all correspondence messages of a conversation. As a result, it can identify topics discussed by parties other than the user of the device, and the system can adjust a language model to account for the topics identified. When the system determines that a topic has gone idle or changed, it can shift priorities of words or combinations of words in a language model. Several topics can be accounted for at a given time, and the disclosed system can optimize a language model for the multiple topics. In some implementations, the system forms a linguistic graph across multiple users, enabling the system to anticipate lexical needs before a party even starts drafting a correspondence message. For example, the system may disseminate an optimized language model among related parties. Accordingly, if two parties are discussing a particular subject, and a user initiates a conversation with one of the two parties, the system may utilize a language model optimized for the conversation between the two parties, anticipating the lexical needs of the user for the new conversation.

The system is effectively a combination of a text-based messaging application and an input method editor (IME, such as a virtual keyboard with predictive text input). Because these two components are integrated into a common technology stack, they can share data back and forth. Thus, the IME may maintain a dialogue-relevant word list. Such a list would include words that the system deems relevant to the IME at any point in time, so that words may be added/removed from the list based on various input including words that are currently appearing in the conversation, or words that are associated with a topic that has appeared in the conversation. The system can likewise modify the list based on words trending in recent conversations between participants in that conversation, or words associated with topics that have been trending in recent conversations between participants in the conversation.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for optimizing a language model used for language prediction based on a topic of a conversation or an anticipated topic of a conversation. The systems are described with respect to a number of processes that they may implement and numerous examples of how they may be implemented.

### Suitable Environments

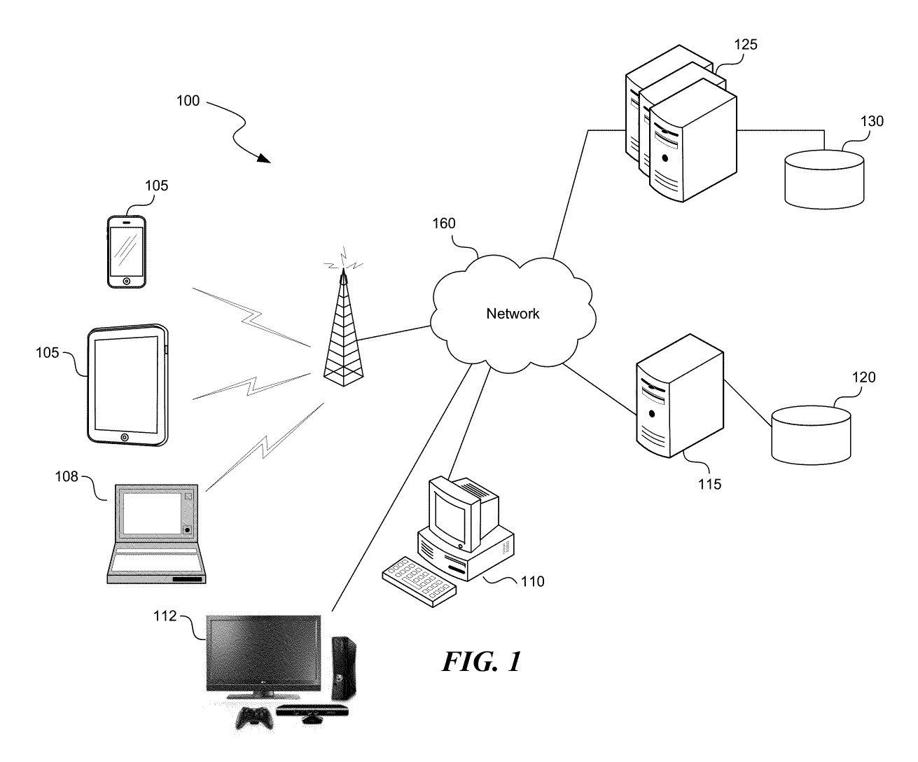

FIG. 1 and the following discussion provide a brief, general description of a suitable computing environment 100 in which a system for optimizing a language model, as described herein, can be implemented. Although not required, aspects and implementations of the invention will be described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system according to embodiments of the invention operates in or among mobile devices 105, laptop computers 108, personal computers 110, video game systems 112, and one or more server computers 115. The mobile devices 105, laptop computers 108, personal computers 115, and video game systems 112 communicate through one or more wired or wireless communication networks 160 with the server 115. A data storage area 120 contains data utilized by the system, and, in some implementations, software necessary to perform functions of the system. For example, the data storage area 120 may contain language models and correspondence messages.

The system communicates with one or more third party servers 125 via public or private networks. The third party servers include servers maintained by entities, such as social networking companies, that send correspondence messages, and the like, to the server 115 or to a computing device (e.g., mobile device 105) over the network. The mobile devices 105, laptop computer 108, personal computers 110, video game systems 112, and/or another device or system, display a user interface that includes predicted text and a messaging input field for receiving text input from a user.

A system for optimizing a language model, as disclosed herein, may operate as part of or in conjunction with a language recognition system, or another system, on various computing devices, such as mobile devices 105, laptop computer 108, personal computers 110, and video game systems 112, and other devices capable of receiving user inputs (e.g., such as navigation system 130 or vehicle-based computer). Each of these devices can include various input mechanisms (e.g., microphones, keypads, and/or touch screens) to receive user interactions (e.g., voice, text, and/or handwriting inputs).

### Suitable System

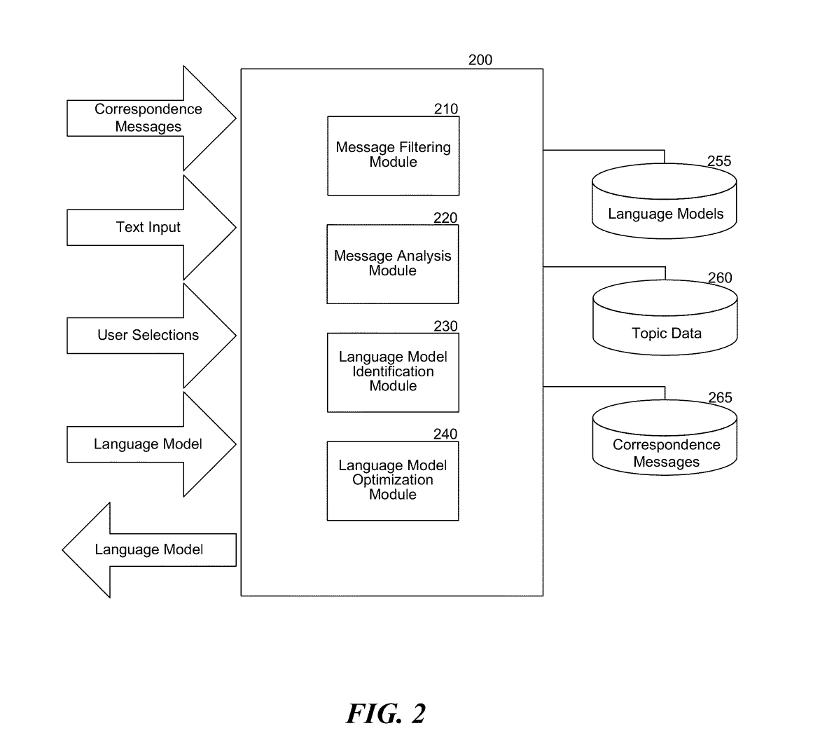

FIG. 2 is a block diagram of a system 200 for optimizing a language model based on a topic identified in correspondence messages. The system 200 can be implemented as part of or in conjunction with a language prediction system. For example, a language prediction system operating on a device may comprise a next word prediction application that uses the system 200 to identify an optimized language model for providing next word prediction for a virtual keyboard. The system may operate on the mobile devices 105, laptop computer 108, personal computers 110, video game systems 112, and/or another device or system that receives text input from a user, or it may be distributed among a device and, for example, the server 115.

The system 200 includes a message filtering module 210, a message analysis module 220, a language model identification module 230, and a language model optimization module 240. The system stores data in and accesses data from language models data storage 255, topic data storage 260, and correspondence messages data storage 265. The system receives correspondence messages, text input, user selections, and a language model, and outputs a language model.

Correspondence messages include text-based messages transmitted between at least two parties. One party may be a user of a device utilizing an optimized language model generated by the system 200 for language prediction. However, messages may also be transmitted between two or more parties who are not the user. For example, the system may store correspondence messages transmitted between two parties who are frequent contacts of a user of a device. In order to optimize a language model on the device, the system can anticipate a topic for future conversations between either of the two parties and the user based on topics it discovers in messages between the two parties.

Correspondence messages can be in any of a number of different formats. Correspondence messages include short message services (SMS) messages, multimedia messaging service messages (MMS), email messages, instant messages, messages posted to a public forum or message board, and so forth. Correspondence messages are received from messaging applications, directly from parties sending correspondence messages, and from third party services, such as social media services. The system 200 may also receive correspondence messages directly from a user of a device, via, for example, a virtual keyboard application.

Text input includes text submitted by a user via a device, including text entered by a keyboard but not submitted by the user. For example, text input includes text of a message being drafted by a user. In some implementations, the system attempts to identify a topic in text being entered by a user as the user enters the text. In some implementations, the system does not receive or does not use text entered but not submitted by a user of a device, and instead only uses correspondence messages sent between parties.

User selections include selections by a user of text identified by a language prediction application. In some implementations, the system 200 identifies a topic of a message based at least in part on user selections. Additionally, in considering whether a topic is still active, the system may consider whether any words related to previously-identified topics have been selected by a user for entry into a message. For example, the system may receive an indication of a selection of a word identified by a next word prediction application, and compare the word to active topics used for optimizing a language model used by the next word prediction application. Based on the comparison, the system can prolong an active status of a topic previously identified. User selections also include information related to a selection by a user to enter text in a messaging application. For example, a user selection may include information describing an intended recipient of a message.

The system 200 receives as input a language model, and also outputs a language model. The received language model may be a language model used by a language predication application. For example, a keyboard utilizing next word prediction may continuously or periodically update a language model used for predicting user input, and the system may continuously or periodically receive and optimize updated language models. In some implementations, a received language model identifies a language model stored by the system 200 in language models data storage 255. The outputted language model includes an optimized language model. In some implementations, the outputted language model includes parameters for modifying a language model used by another system. For example, the outputted language model may include data for updating probabilities associated with words of a language model. A language model can record various information to help in recognizing or producing predicted language, including, but not limited to, lists of individual words (unigrams) and their relative frequencies of use, and the frequencies of word pairs (bigrams), triplets (trigrams), and higher-order n-grams. In some embodiments, changes to a language model are provided to the system.

The message filtering module 210 maintains and filters correspondence messages for identifying relevant topics for a user. The message filtering module receives correspondence messages, text input, and user selections, and retrieves from and stores correspondence messages in correspondence messages data storage 265. The message filtering module 210 filters correspondence messages based on various criteria. In some implementations, the message filtering module filters correspondence messages based on a user of a mobile device having sent or received a message. The message filtering module can filter messages based on a party to whom a message was sent, a party from whom a messages was received, and so forth. For example, the message filtering module may filter messages according to a user and a party to whom the user has addressed a message. In some implementations, the system filters messages based on a time a message was sent. For example, the system may filter out messages sent or received more than a predetermined time period before the system optimizes the language model. The message filtering module also can filter messages based on an application used for generating or sending a message, or based on a format of a message.

The message analysis module 220 identifies topics in filtered correspondence messages. The message analysis module also examines new messages to determine whether previously-identified topics are still active. A topic is something referred to in one or more correspondence messages, explicitly or implicitly. Topics include objects, ideas, feelings, places, and the like. The system can identify multiple topics in correspondence messages. For example, successive correspondence messages may refer to a Mariners baseball game, and the system identifies both “Mariners” and “baseball” topics. In some implementations, the system raises priorities for words associated with a topic by a greater degree than priorities for words associated with other topics.

Topics are identified in many ways. In some implementations, a topic is identified based on keywords appearing or repeated in correspondence messages. For example, the message analysis module may compare correspondence messages to a list of keywords, and determine that a topic has been referred to if an associated keyword is found in the correspondence messages. In some implementations, the message analysis module identifies a topic based on a frequency that a word or phrase is used in correspondence messages. For example, if a word is used three times among five messages sent and received by a user, the system may identify the word or an associated word as a topic. In some implementations, the message analysis module identifies a topic based on a question and answer pair. For example, the system may identify a question in a message from a user to a party and a one word response by the user, and the system may determine that the word responded with by the user is a topic. Thus, for the question and answer pair, “Where are you going to visit on vacation?” and, “London,” the system may identify “London” as a topic.

The language model identification module 230 identifies a language model to optimize. Language models may be received by the system or identified in language models data storage 255. In some implementations, the language model identification module identifies a default language model. In other implementations, the language model identification module selects a language model to optimize based on a language model previously used for a user. For example, the language model identification module may identify a language model to optimize based on a language model that was previously used by a language prediction application for predicting input by a user, or a language model previously used for predicting input by the user for message sent to a particular recipient. The identified language model may comprise a language model that has already been optimized by the system 200.

The language model optimization module 240 optimizes the language model identified by the language model identification module 230 based on topics identified by the message analysis module 220 and/or topics anticipated based on a received user selection. As discussed above, the message analysis module 220 can identify topics in past correspondence messages. The language model optimization module 240 also identifies topics in a received user selection. For example, user selection data may include that recipient of a message being drafted is a particular party or type of party. For example, a user selection may indicate that the user has chosen to initiate an instant messaging session with customer service related to a particular technology or product. The language model may determine that the technology or product for which the customer service request is initiated is a topic.

The language model optimization module optimizes a language model by increasing or reducing a priority of a word in the language model. For example, the language model optimization module may adjust a probability associated with a word or multiple words from the language model based on topics identified by the message analysis module 220 and topics in user selections. The language model optimization module optimizes a language model based on information associated with topics identified in correspondence messages. Topics identified by the message analysis module 220 may be compared to data stored in topic data storage 260. Topic data storage may contain data correlating words and phrases with topics. For example, a topic, “Baseball,” may be associated with words and phrases including “Babe Ruth,” “Ichiro,” “homer,” “grand slam,” “Cooperstown,” “7th inning stretch,” “Take Me Out to the Ballgame,” and “hot dog.”

In some implementations, data correlating topics and associated words and phrases may be automatically generated by the system by examining correspondence messages identified as being related to a topic for keywords or phrases. In some implementations, data correlating topics and associated words and phrases is created by a technician. The data correlating words and phrases with topics may include a ranking or weight indicating a degree to which a word or phrase is related to a topic. In some implementations, the language model optimization module alters a priority associated with a word in a language model based on a ranking or weight associated with the word. For example, “Babe Ruth” and “Ichiro” may be associated with a weight of five, and “Cooperstown” and “7th inning stretch” may be associated with a weight of three, and the language model optimization module may alter a priority associated with these words by a factors of five and three, respectively.

### Suitable Processes

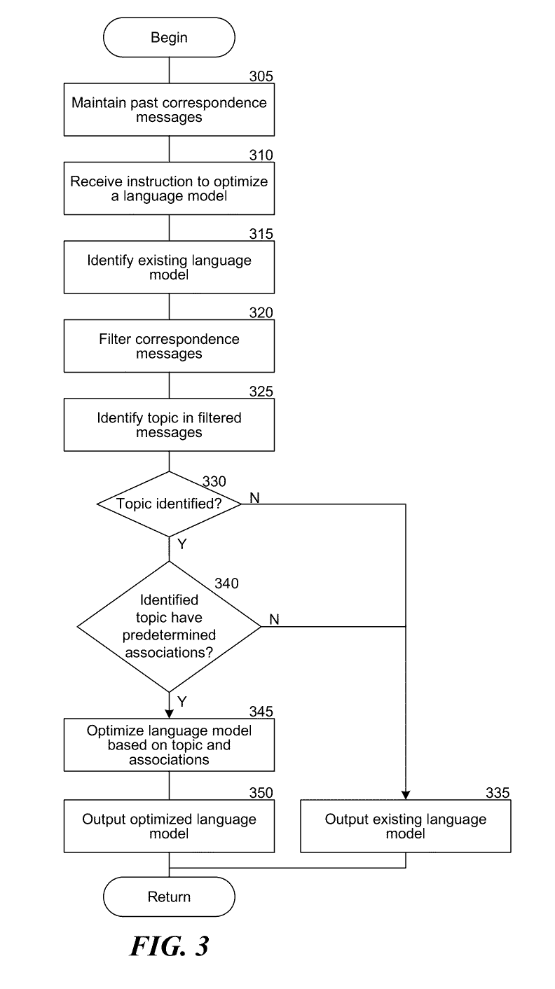

The system 200 improves the accuracy of language prediction applications by optimizing a language model used for predicting text. The system optimizes an existing language model based at least in part on content of correspondence messages. A device utilizing next word prediction, autocomplete, or a similar language prediction system utilizes the optimized language model to predict with improved accuracy text for a user to enter into a correspondence message. FIG. 3 is a flow diagram of a process 300 performed by the system 200 for identifying an optimized language model based on content of correspondence messages.

At a block 305, the system 200 maintains past correspondence messages. As discussed above, correspondence messages include text-based messages exchanged between two or more parties. The parties can include a user of a computing device on which the system is operating and/or other parties. The correspondence messages may be received by the system continuously or periodically.

At a block 310 the system 200 receives an instruction to optimize a language model for a language prediction application. The instruction may be generated when the language prediction application is launched, such as after a user selects to enter text into a correspondence message or while a user is entering text. The instruction may also be received after a device launches a virtual keyboard. In some implementations, the system is configured to continuously or periodically optimize a language model based on new correspondence messages drafted by the user or by other parties.

The instruction to identify an optimized language model may include parameters or other information related to the instruction. In some implementations, the system receives context information related to text entry by a user. For example, the system may receive information related to a party to whom the user is drafting a message, such as the party's name or occupation, whether multiple parties are addressed by the message, and so forth. Context information also includes an application that is to receive text entry by a user, and text already entered by the user.

At a block 315, the system 200 identifies an existing language model. The system may identify a default language model used by the language prediction application. In some implementations, the system identifies a language model from among multiple language models, or identifies parameters to apply to a default language model. For example, the system may identify a language model that has been modified based on information learned about a user or based on a user's use of a device. The existing language model may already have been optimized by the system 200. For example, the system may identify an existing language model that was already optimized for the user based on topics identified in correspondence messages.

At a block 320, the system 200 filters the correspondence messages. The system may filter messages according to various criteria. In some implementations, messages are filtered based on the parameters or other information related to the instruction received at block 310. For example, the system may identify in information related to a received instruction that a user is drafting a message to a contact of the user, and the system may filter messages to identify only those transmitted between the user and the contact, or between the contact and another party.

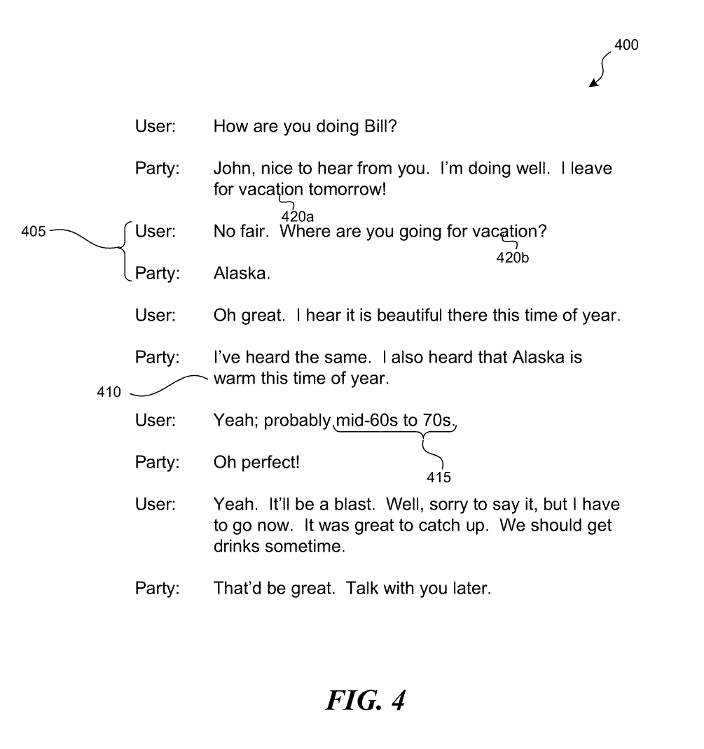

At a block 325, the system 200 identifies a topic in the filtered correspondence messages. In some implementations, the system identifies a topic in information related to the instruction received at block 310. For example, the instruction may include that a message being drafted is addressed to a customer service representative for a particular product. The system may identify the product as a topic. The system also identifies topics based on identifying topics or words or phrases related to topics in correspondence messages. FIG. 4 shows representative correspondence messages 400 transmitted between a user and a party. The system may identify a number of different topics in the messages. For example, the system may identify a topic, “Alaska,” based on a question and answer pair 405. The system may also identify a topic, “weather,” based on keyword 410 “warm” and phrase 415 “mid 60s to 70s.” The system can also identify a topic, “vacation,” based on a first usage 420a and a second usage 420b in successive messages.

Returning to FIG. 3, at a decision block 330, the system 200 determines whether a topic was identified in the correspondence messages. If no topic was identified, the system proceeds to a block 335, and outputs the existing language model. Alternatively, the system may generate a notification that no optimized language model has been generated. If a topic is identified, the system proceeds to a decision block 340.

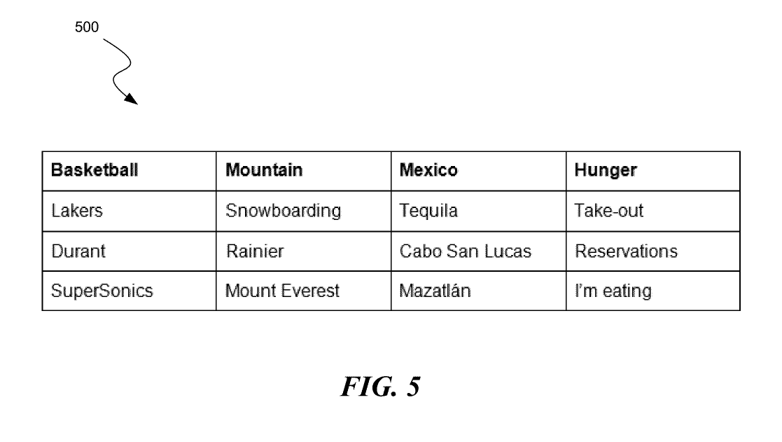

At decision block 340, the system 200 determines whether the identified topic has a predetermined association with any words or sequence of words of the existing language model. In some implementations, the system compares identified topics with a list maintained by the system that correlates topics with words or phrases that the topics have a predetermined association with. FIG. 5 shows a representative table 500 correlating topics with associated words, containing topics in a first row and associated words in subsequent rows of each respective topic's column. The table 500 includes topic “Basketball” with associated words “Lakers,” “Durant,” and “SuperSonics.” Similarly, topics “Mountain,” “Mexico,” and “Hunger,” have associated words.

If the identified topic does not have predetermined associations, the process 300 proceeds to a block 335, and the system 200 outputs the existing language model. In some implementations, rather than identifying topics before determining whether the topics have predetermined associations, the system 200 identifies topics only if they have predetermined associations. For example, the system may compare a list of topics and related words to words and phrases in correspondence messages. If at block 340 the system determines that the identified topic does have predetermined associations, the process proceeds to block 345.

At block 345, the system 200 optimizes an existing language model based on the identified topic and corresponding associations. The system optimizes the existing language model by raising a priority in the existing language model of a word or sequence of words associated with the identified topic. For example, the system may assign a greater probability to a word or phrases considered by the language model. Referring to the Table 500 of FIG. 5, if topic “Mexico” is identified, the system would assign higher priority to words “Tequila,” “Cabo San Lucas,” and “Mazatlan” than the probabilities assigned to these words in the existing language model. In some implementations, the system identifies a pre-existing language model to be used based on an identified topic.

In some implementations, the system increases, by a predetermined or variable amount or percentage, a probability of a word or phrase associated with an identified topic. The system may implement this change by weighting or otherwise modifying a probability associated with a word according to the language model. In some implementations, a probability or weight is associated with each of the words or phrases associated with a topic, indicating a strength of association or relatedness between the topic and the associated word. The probability or weight may be used for optimizing the language model. For example, associated word “Lakers” may have an association weight of 3 while associated word “SuperSonics” has an association weight of2. Thus, when the language model is optimized, the probability associated with “Lakers” will triple and the probability associated with “SuperSonics” will double.

When the system identifies multiple active topics in a conversation, it raises the priority for associated words of each topic. Sometimes, a word's priority is increased by a relatively greater amount as a result of it being associated with two or more topics identified in a conversation. In some implementations, the system applies a function to a language model, which causes the probability associated with a word to change over time or as a result of an event or a criteria being met. For example, optimizations for a language model may expire after a certain time period. Similarly, priority for a word may be reduced over time or as further messages are transferred between parties and words associated with an identified topic are not identified in new correspondence messages. By doing this, the system may observe a shift in conversation and re-optimize the language model accordingly. At a block 350, the system 200 outputs the optimized language model. In some implementations, the system passes the optimized language model to devices associated with other parties. Accordingly, language predication applications operating on the other devices can receive the benefits of a language model optimized based on topics that the other parties are likely to discuss.

The system 200 can anticipate a topic for a conversation between two parties and adjust a language model accordingly. In some implementations, the system anticipates a topic not identified in past correspondence messages. As discussed above, the system can anticipate a topic based on a received user selection. One such topic may include customer service related to a particular product or service. Other topics that may be identified based on a received user selection include a region or geographic location of the user, an industry or business associated with the user, a group or type of group that a message is addressed to, or the like, and the system can optimize a language model according to the region or geographic location.

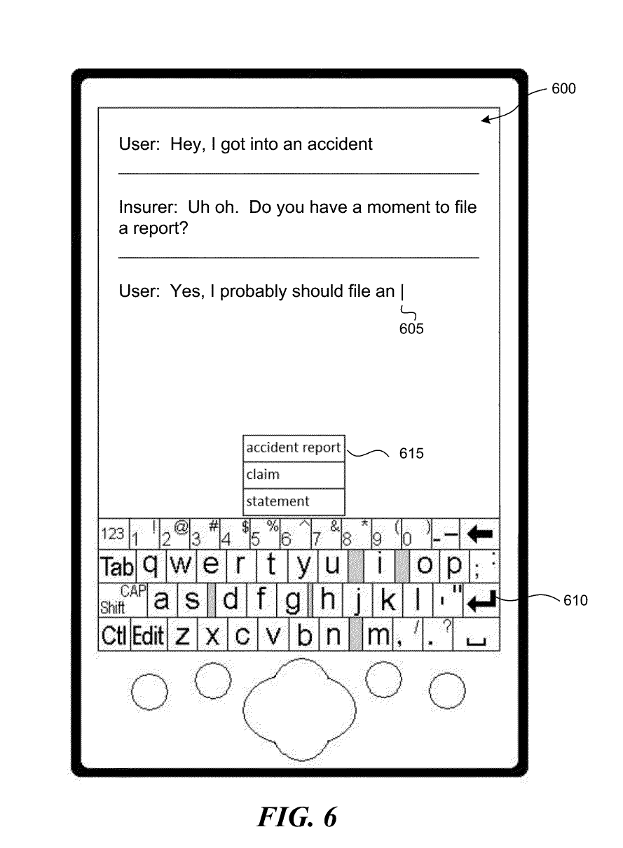

FIG. 6 shows a representative interface 600 for an instant messenger application displaying correspondence messages between a user and a customer service representative of an insurance company. A cursor 605 indicates a location that a user is entering text at. A virtual keyboard 610 displays keys and predicted text 615 that a user may select for entering at the cursor. The predicted text 615 includes “accident report,” “claim,” and “statement.” The predicted text has been identified using a language model optimized for customer service related to auto insurance. For example, a user may select via a computing device to commence an instant messaging session with a customer service representative for an auto insurance company. The system may receive information related to the request, including that the request is being sent to a representative of an auto insurer. Based on this information, the system identifies “auto insurance” and “customer service” as topics for the conversation. The system then optimizes a language model based on these topics, raising a priority for “accident report,” “claim,” and “statement” in a language model. Finally, when the keyboard 610 using next word prediction predicts a next word to display to the user based on the language model, the keyboard identifies words related to “auto insurance” and “customer service” topics.

### Conclusion

Those skilled in the art will appreciate that the actual implementation of a data storage area may take a variety of forms, and the phrase “data storage” is used herein in the generic sense to refer to any storage device that allows data to be stored in a structured and accessible fashion using such applications or constructs as databases, tables, linked lists, arrays, and so on.

The words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the disclosure is not intended to be exhaustive or to limit the disclosure to the precise form disclosed above. While specific examples for the disclosure are described above for illustrative purposes, various equivalent modifications are possible within the scope of the disclosure, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various examples described above can be combined to provide further implementations of the disclosure. Some alternative implementations of the disclosure may include not only additional elements to those implementations noted above, but also may include fewer elements.

These and other changes can be made to the disclosure in light of the above Detailed Description. While the above description describes certain examples of the disclosure, and describes the best mode contemplated, no matter how detailed the above appears in text, the disclosure can be practiced in many ways. Details of the system may vary considerably in its specific implementation, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific examples disclosed in the specification, unless the above Detailed Description section explicitly defines such terms. Accordingly, the actual scope of the disclosure encompasses not only the disclosed examples, but also all equivalent ways of practicing or implementing the disclosure under the claims.

To reduce the number of claims, certain aspects of the disclosure are presented below in certain claim forms, but the applicant contemplates the various aspects of the disclosure in any number of claim forms. For example, while only one aspect of the disclosure is recited as a computer-readable medium claim, other aspects may likewise be embodied as a computer-readable medium claim, or in other forms, such as being embodied in a means-plus-function claim. (Any claims intended to be treated under 35 U.S.C. §112, ¶6 will begin with the words “means for”, but use of the term “for” in any other context is not intended to invoke treatment under 35 U.S.C. § 112, ¶6.) Accordingly, the applicant reserves the right to pursue additional claims after filing this application to pursue such additional claim forms, in either this application or in a continuing application.

We claim:

1. A tangible computer-readable storage medium containing instructions for performing a method of optimizing a language model based on a topic identified in correspondence messages, the method comprising:
maintaining correspondence messages,
wherein the correspondence messages have been transferred from a first party to at least one other party;
receiving an indication to optimize a language model,
wherein the language model is to be optimized based at least in part on a topic identified in correspondence messages;
selecting a language model to be optimized;
identifying correspondence messages associated with at least one of the first party or the at least one other party;
determining a topic in the correspondence messages associated with at least one of the first party or the at least one other party;
identifying a word and/or phrase associated with the determined topic;
optimizing the language model,
wherein optimizing the language model includes adjusting a priority in the language model associated with the identified word and/or phrase; and
outputting the language model.

2. The tangible computer-readable storage medium of claim 1, wherein the first party is a user of a device operating a language prediction application, and wherein the identified correspondence messages were sent or received by the user.

3. The tangible computer-readable storage medium of claim 1, wherein determining a topic in the correspondence messages includes identifying keywords associated with a topic in correspondence messages.

4. The tangible computer-readable storage medium of claim 1, wherein determining a topic in the correspondence messages includes comparing, to a threshold value, a frequency that a word or phrase associated with a topic is used.

5. The tangible computer-readable storage medium of claim 1,
wherein the indication to optimize a language model includes information related to a message being drafted by a user, and
wherein the information related to the message being drafted by the user includes an intended recipient of the message being drafted.

6. The tangible computer-readable storage medium of claim 1, wherein the indication to optimize a language model includes information related to an intended recipient of the message, and wherein the method further comprises:
determining a second topic based at least in part on the intended recipient of the message; and
identifying a word and/or phrase associated with the determined second topic,
wherein optimizing the language model further includes adjusting a priority in the language model associated the identified word and/or phrase associated with the determined second topic.

7. The tangible computer-readable storage medium of claim 1, wherein the method further comprises:
determining that the topic is no longer active; and
adjusting the priority in the language model associated with the identified word and/or phrase to a previous priority level.

8. The tangible computer-readable storage medium of claim 1, wherein the indication to optimize a language model is generated by a language prediction application operating on a device.

9. A system for optimizing a language model based on a topic identified in correspondence messages, the system comprising:
a memory containing computer-executable instructions of:
a message filtering module configured to:
maintain correspondence messages,
wherein the correspondence messages have been transferred from a first party to at least one other party;
identify correspondence messages associated with at least one of the first party or the at least one other party;
a message analysis module configured to:
determine, in the correspondence messages, a topic associated with at least one of the first party or the at least one other party;
identify a word and/or phrase associated with the determined topic;
a language model identification module configured to select a language model to be optimized; and
a language model optimization module configured to:
receive an indication to optimize a language model,
wherein the language model is to be optimized based at least in part on a topic identified in the identified correspondence messages;
optimize the language model,
wherein the language model is optimized by adjusting a priority in the language model associated with the identified word and/or phrase associated with the determined topic; and
output the language model; and
a processor for executing the computer-executable instructions stored in the memory.

10. The system of claim 9, wherein the first party is a user of a device operating a language prediction application, and wherein the identified correspondence messages were sent or received by the user.

11. The system of claim 9, wherein the message analysis module is further configured to determine a topic in the correspondence messages based at least in part on identifying keywords associated with the topic in correspondence messages.

12. The system of claim 9, wherein the message analysis module is further configured to determine a topic in the correspondence messages based at least in part on a comparison, to a threshold value, of a frequency that a word or phrase associated with the topic is used.

13. The system of claim 9,
wherein the indication to optimize a language model includes information related to a message being drafted by a user, and
wherein the information related to the message being drafted by the user includes an intended recipient of the message being drafted.

14. The system of claim 9, wherein the indication to optimize a language model includes information related to an intended recipient of the message, and wherein:
the message analysis module is further configured to determine a second topic based at least in part on the intended recipient of the message; and
identify a word and/or phrase associated with the determined second topic,
wherein the language model optimization module is further configured to optimize the language model by adjusting a priority in the language model associated the identified word and/or phrase associated with the determined second topic.

15. The system of claim 9, wherein the message analysis module is further configured to determine that the topic is no longer active; and the language model optimization module is further configured to adjust the priority in the language model associated with the identified word and/or phrase to a previous priority level.

16. The system of claim 9, wherein the indication to optimize a language model is generated by a language prediction application operating on a device.

17. A computer-implemented method for optimizing a language model based on a topic anticipated in a correspondence message being drafted, the method performed by a processor executing instructions stored in a memory, the method comprising:
receiving an indication to optimize a language model,
wherein the language model is to be optimized based at least in part on an anticipated topic of a correspondence message being drafted,
wherein the indication to optimize the language model includes an intended recipient of the correspondence message;
selecting a language model to be optimized;
determining an anticipated topic based at least in part on the intended recipient of the correspondence message;
identifying a word and/or phrase associated with the determined topic;
optimizing the language model,
wherein optimizing the language model includes adjusting a priority in the language model associated with the identified word and/or phrase; and
outputting the language model.

18. The method of claim 17, wherein the intended recipient of the correspondence message is a customer service representative.

19. The method of claim 17, further comprising:
identifying a second topic in correspondence messages sent between a user and the intended recipient; and
identifying a word and/or phrase associated with the identified second topic,
wherein optimizing the language model includes adjusting a priority in the language model associated with the identified word and/or phrase.

20. The method of claim 17, wherein the indication to optimize a language model is generated by a language prediction application operating on a device.
